(19) United States
(12) Patent Application Publication
(10) Pub. No.: US 2011/0272855 A1
(43) Pub. Date: Nov. 10, 2011

(54) Techniques For Patterning Valve Components

(75) Inventors: Joseph A. Luongo, Walpole, MA (US); Michael Budnick, Blackstone, MA (US); Mark W. Moeller, Kingston, MA (US); James P. Murphy, Franklin, MA (US); Geoff C. Gerhardt, Millbury, MA (US); Keith Fadgen, Hope Valley, RI (US); Joseph D. Michienzi, Plainville, MA (US)

(73) Assignee: WATERS TECHNOLOGIES CORPORATION, Milford, MA (US)

(21) Appl. No.: 13/125,182

(22) PCT Filed: Oct. 28, 2009
(86) PCT No.: PCT/US09/62304

§ 371 Date: Jun. 14, 2011

Related U.S. Application Data
(60) Provisional application No. 61/108,965, filed on Oct. 28, 2008.

(51) Int. Cl. B29C 59/02

(52) U.S. Cl. 264/293

(57) ABSTRACT

Described are techniques for fabricating one or more parts of a valve used in a liquid chromatography system. At least one of a rotor and a stator are provided. The rotor is included in the valve and has a first surface facing a stator. The stator is included in the valve and has a second surface facing the rotor. A pattern is formed in at least one of the first surface and the second surface. Forming the pattern includes compressing the at least one surface by applying pressure thereto causing displacement of material to form at least one groove.

### CROSS REFERENCE TO RELATED APPLICATIONS

This application claims benefit of and is a continuation of U.S. Provisional Application No. 61/108,965, filed Oct. 28, 2008. The contents of this application is expressly incorporated herein by reference in its entirety.

### BACKGROUND

1. Technical Field

This application generally relates to techniques for use with fabrication of components, and more particularly to techniques for patterning a surface of a component part.

2. Description of Related Art

Samples may be processed in a laboratory or other environment for a variety of different purposes and applications, Chromatography refers to techniques for separating sample mixtures. Common chromatographic techniques include gas chromatography (GC) and liquid chromatography (LC). With an instrument that performs LC, a liquid sample to be analyzed is introduced in small volumes for analysis. The sample may be injected into a solvent stream which is carried through a column. The compounds in the sample can then be separated by traveling at different speeds through the column resulting in the different compounds eluting from the column at different times. In connection with High Performance Liquid Chromatography (HPLC) and Ultra Performance Liquid Chromatography (HPLC), pressure is used to facilitate fluid flow in the system through the chromatographic column.

An instrument that performs LC or GC includes different components that may be fabricated using a variety of different techniques. The fabrication of the components may include patterning a surface of a component part. One technique uses a machine or tool to cut into the surface of the component part causing removal of material to produce a desired pattern on the surface.

### SUMMARY OF THE INVENTION

In accordance with one aspect of the invention is a method for fabricating one or more parts of a valve used in a liquid chromatography system. At least one of a rotor and a stator are provided. The rotor is included in the valve and has a first surface facing a stator. The stator is included in the valve and has a second surface facing the rotor. At least one of said first surface and said second surface is patterned. Patterning includes compressing said at least one surface by applying pressure thereto causing displacement of material from said at least one surface to form at least one groove. The valve may be an injection valve. Patterning may include heating said at least one surface prior to compressing.

In accordance with another aspect of the invention a method for fabricating parts of a valve. At least one of a rotor and a stator are provided. The rotor is included in the valve and has a first surface facing a stator. The stator is included in the valve and has a second surface facing the rotor. At least one groove is formed on at least one of said first surface and said second surface. The at least one groove is formed using a process without machining said at least one surface to form said at least one groove. The at least one groove may be formed by compressing said at least one surface to displace material therefrom. The at least one groove may be formed using injection molding. The at least one groove may be formed by embossing a pattern on said at least one surface using an embossing tool and, prior to embossing, said at least one surface may be heated. A first groove may be formed in one of the first and second surfaces by heating the surface containing the first groove prior to forming the first groove. There may be no edge burrs formed at a perimeter of the first groove, no exposed or raised fibers on a surface area of the first groove, and no surface voids formed on a surface area of the first groove.

In accordance with another aspect of the invention is a method for fabricating one or more parts of a valve in a chromatography system. At least one of a rotor and a stator are provided. The rotor is included in the valve and has a first surface facing a stator, and the stator is included in the valve and has a second surface facing the rotor. At least one of said first surface and said second surface is patterned to form at least one groove therein. Patterning includes performing one or more of: compressing said at least one surface by applying pressure thereto causing displacement of material to form said at east one groove, and using a mold having at least one groove formed therein.

In accordance with another aspect of the invention is a rotor comprising at least one groove formed on a surface thereof wherein there are no edge burrs formed at a perimeter of said at least one groove, no exposed or raised fibers on a surface area within said at least one groove, and no surface voids formed on a surface area within said at least one groove.

In accordance with another aspect of the invention is a stator comprising at least one groove formed on a surface thereof wherein there are no edge burrs formed at a perimeter of said at least one groove, no exposed or raised fibers on a surface area within said at least one groove, and no surface voids formed on a surface area within said at least one groove.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example illustrating an embodiment of a rotor having a surface patterned in accordance with the techniques described herein;

FIG. 2 is an example illustrating use of the embossing techniques herein in an embodiment in connection with patterning a surface;

FIG. 3 is an example illustrated how tensile strength of various PEEK (polyether-ether-ketone) materials changes in accordance with temperature;

FIG. 4 is a flowchart of processing steps that may be performed in an embodiment in connection with fabricating a rotor in accordance with the embossing techniques herein to form a pattern on a rotor surface;

FIG. 5 is an example illustrating an embodiment of a second rotor having a surface patterned in accordance with the techniques described herein and illustrating an embodiment of a stator having a surface patterned in accordance with the techniques described herein that may be used with the second rotor;

FIG. 6 is a flowchart of processing steps that may be performed in an embodiment in connection with a second technique for fabricating a rotor in accordance with injection molding techniques to form a pattern on a rotor surface; and

FIG. 7 is a table of exemplary surface defects and characterizations resulting from producing a patterned surface using machining and embossing techniques described herein.

### DETAILED DESCRIPTION OF EMBODINIENT(S)

Described in following paragraphs are techniques that may be used in fabricating components of a system such as a liquid chromatography (LC) system. The LC system may be, for example, a High Performance Liquid Chromatography (HPLC) or an Ultra Performance Liquid Chromatography (HPLC) system such as the ACQUITY UPLC® and nanoACQUITY UPLC® systems from Waters Corporation of Milford Mass. An LC system such as the foregoing from Waters Corporation may operate under high pressure such as in the range of 5000 PSI (e.g, exemplary for some HPLC systems) to 15000 PSI (exemplary for some HPLC systems). An LC system may include components fabricated using a variety of different techniques. For example, a typical LC system may include an injector used to inject controlled volumes of a sample, either manually or automatically, into a fluid stream which carries the sample to an LC column where the sample may then be separated. The injector may include an injector valve used in connection with controlling or regulating the introduction of fixed volumes of a sample for analysis in the LC system. The injector valve may include one or more parts each having a pattern formed on a surface of the part. The pattern may include, for example, one or more grooves. The surface upon which the grooves are formed may also be in contact with the fluid containing the sample. That is, the groove or other patterned area may form part of the flow path of the sample in the LC system.

Different fabrication techniques may be used in connection with producing the pattern on the surface of an injector valve part or of another component in the LC system. One such technique, that may be referred to as machining, uses a machine or tool to cut into the surface of the part. Cutting into the surface causes removal of material to produce a desired pattern on the surface. For example, a groove may be formed by drilling into the surface to a particular depth and direction to generate the desired pattern. Use of a technique such as the foregoing may result in undesirable surface effects in the patterned area such as surface roughness or unevenness, edge burrs, machining debris in the patterned area, exposed fibers, increased overall surface area having contact with the sample, and the like. In connection with a patterned area that is also in contact with the sample, the foregoing undesirable surface effects from the machining fabrication process to form surface patterns may cause an element, such as a peptide, in a sample to cling to the surface and interfere with sample recovery. For example, a sample may include peptides that have an affinity for a particular exposed fiber in the groove surface increasing the likelihood of peptide loss and interference with sample analysis. Thus, it may be desirable to use a fabrication technique to pattern surfaces which reduces the overall surface area and/or other undesirable surface effects that may lead to peptide loss in the sample.

What will be described in following paragraphs are techniques that may be used in connection with patterning a surface that reduces the foregoing undesirable surface effects typically resulting from machining. For purposes of illustration, the techniques herein are illustrated with respect to fabrication of parts of an injector valve. Although the foregoing is described herein with reference to an injector valve for purposes of illustration, it will be appreciated by those skilled in the art that the fabrication techniques have broader applicability. For example, the techniques herein may be used with other valves (e.g., trap valve, vent valve, and the like), other components of the injector, or another element of an LC system. The techniques herein may also be used with fabricating components from other systems, devices, and instruments, such as a gas chromatography (GC) system. It should be noted that although the techniques herein may be used in connection with patterning surfaces having contact with the sample, the techniques herein may also be used in connection with patterning surfaces which may not be included in the fluid path of the sample through the LC system.

As described in following paragraphs, one or more parts of an injector valve assembly may be fabricated using the patterning techniques herein. As will be appreciated by those skilled in the art, an injector valve assembly may include other parts and may have additional detail than as described herein for purposes of illustrating the techniques herein. Additionally, it should be noted that any details provided herein regarding the injector valve assembly are for purposes of illustration and should not be construed as a limitation of the patterning techniques described herein. Injector valve assemblies, for example, as described in WO 2005/079543 A2 (PCT/US2005/005714) PIN VALVE ASSEMBLY, Keene et al., which is incorporated by reference herein, are generally known in the art. A valve, such as an injector valve that may be used in an LC system, may include a stator and a rotor acting together to connect or align ports of the valve. The rotor may be actuated in a rotational manner relative to the axis of the valve in order to vary the position of the rotor relative to the stator, which remains stationary. A first surface of the rotor may face a surface of the stator. The rotor may be a removable disk which, as will be described in following paragraphs, may include a pattern formed on the first surface using embossing techniques described herein. The rotor may be included in a valve assembly including a drive shaft coupled to another component, such as an engine or motor, to facilitate actuating the valve assembly as will also be described in connection with loading a volume of sample.

What will now be described is a rotor having a pattern formed on a surface thereof using the embossing techniques described herein. The rotor may be included in an injector valve of an LC system.

It should be noted that exemplary measurements are included in connection with figures herein such as those for embodiments of the rotor and stator. The measurements provided in following figures are approximate values and in inches unless otherwise indicated such as those angular degree measurements. The measurements indicated are only examples of what may be included in an embodiment for purposes of illustration and should not be construed as a limitation of techniques herein.

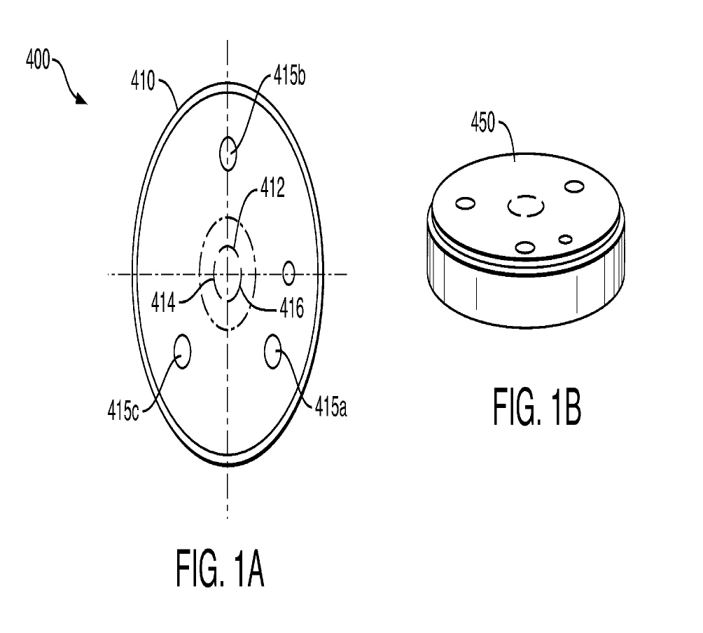

Referring to FIG. 1, shown is an illustration of an embodiment of a rotor that may be patterned in accordance with techniques described herein The rotor of FIG. 1 may be included in an injector valve assembly. The rotor having various views set forth in the example 400 of FIG. 1 may include grooves 412, 414 and 416 on a surface thereof fabricated using embossing techniques herein described in following paragraphs. Element 410 provides a surface view of the rotor 410 facing the stator. The rotor in 410 is illustrated as a disk having 3 grooves 412, 414, and 416 formed on the surface thereof facing the stator. Elements 415a-c are 3 through holes that may be formed in the rotor. The through holes 415a-c may be used to position the rotor in the valve assembly. For example, another part (not shown) included in the valve assembly and in contact with a surface of the rotor not facing the stator may include 3 protrusions with positions corresponding to each of the 3 through holes 415a-c. In this example, each of the grooves may be 0.008 inches in width and hold a volume of 0.04 microliters. Each of the grooves 412, 414, and 416 are located a same distance R from the center of the rotor and are shaped to extend along a portion of a same circumference of a circle having radius R. In this example, the foregoing circle has an exemplary diameter of 0.100 inches. Each groove has a sufficient length to extend about a portion of the circumference associated with a 60 degree angle. Each groove is positioned to be equidistant from the other grooves along the circumference. Element 450 shows a different view of the rotor as a disk included in an outer metal ring such as may be included in an injector valve. As will be described in following paragraphs, the 3 grooves 412, 414 and 416 may be formed using embossing techniques described herein.

A stator (not illustrated) may be included in an injection valve assembly with the rotor of FIG. 1. As known in the art and also described in more detail below, the stator may have a first surface which is not in contact with a surface of the rotor and a second opposing surface which is in contact with the rotor surface having grooves formed therein such as illustrated in the example 400 of FIG. 1. The foregoing first surface of the stator may include a number of ports, such as 6 ports having corresponding port holes through the stator with openings on the second surface. The openings of port holes formed on the second surface of the stator facing the rotor are located a same distance from the center as the 3 grooves 412, 414, and 416 in the rotor 420 of FIG. 1. The foregoing provides for the openings of the port holes on the second stator surface (in contact with the rotor) being in alignment with the rotor grooves 412, 414 and 416.

The rotor is a disk having 3 grooves formed therein in this exemplary valve assembly although the rotor formed using the techniques described herein may have grooves formed therein of any number, shape and size. The rotor actuates in a rotational fashion about its center axis. The actuation causes the grooves located on the rotor surface facing the stator to move providing different fluidic connections to different ports of the stator where a groove forms a channel between two ports through which fluid flows. Tubes may be connected to ports of the stator in the first surface (not facing the rotor) in connection with forming a fluid path of an injected sample into and out of a sample loop. The sample may be forced out of the sample loop by applying pressure such as using a pump. Any of the ports may be inlet or outlet ports with respect to fluid in the LC system depending on the valve configuration and use. In an injector valve of an LC system, the rotor may be actuated to different positions relative to a stationary stator in order to load and then inject volumes of a sample into the LC system. For example, with the 6 port stator and the rotor of FIG. 1, a sample loop may be connected to ports 1 and 4, with a sample injected through port 3. When in the load position, the sample injected through port 3 passes through a groove connecting ports 3 and 4, and into the sample loop. When the rotor is then actuated to a second injection position, a first rotor groove connects ports 5 and 4 and a second rotor groove connects ports 1 and 6. Pressure may be introduced through port 5 to force fluid out of the sample loop through the second rotor groove and the fluid then exits through port 6, such as may be connected to an LC column.

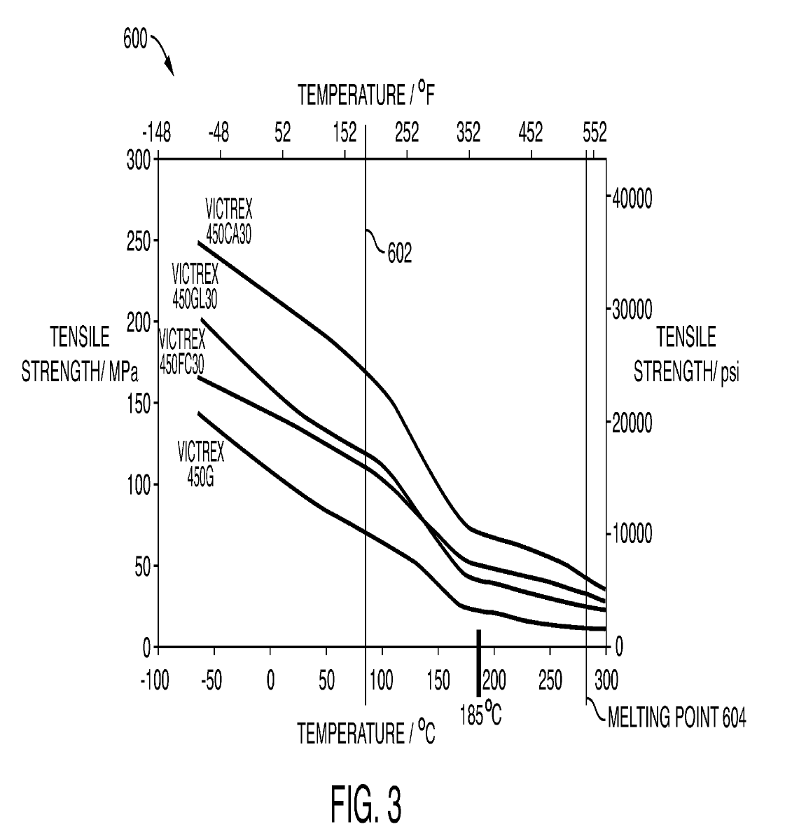

In an embodiment using the techniques herein for embossing grooves on a rotor surface, the rotor can be made of a base polymer and, optionally, one or more other materials in a homogeneous combination. Such other materials may be added to increase the strength and provide fiber reinforcement and other materials may be added as filler. For example, the rotor can be made of a PEEK (polyether-ether-ketone) polymer material with 30% carbon fiber. The rotor may also be made with other polymers such as, for example, Ryton PPS (Polyphenylene Sulfide), VESPEL SP1, and a polyimide. Materials such as carbon or glass fibers may be added to provide strength and reinforcement. Additionally, fillers such as Teflon and/or graphite may be used in combination with the carbon, glass or other fibers. The particular blend of materials, such as the amount and/or types of fillers and reinforcement fiber used, varies based on the specific materials included. The blend may also vary with the different pressures at which the LC system may operate. For example, additional carbon reinforcement may be needed as the pressure of the LC system increases. Particular fillers can be added to improve the coefficient of friction to facilitate actuation of the rotor. As described in following paragraphs, the rotor including a pattern formed on a surface thereof using the embossing techniques herein may be made of any one of a variety of different PEEK materials as illustrated in FIG. 3 where the rotor may be heated, for example, to a temperature selected from an approximate range of 100-200° C. with appropriate pressure for the selected temperature. Optionally heating a rotor or other part and selecting an appropriate pressure for use in connection with embossing techniques herein are described in more detail below.

The stator used in an injection valve with the rotor of FIG. 1 may be made of stainless steel or other suitable material and manufactured using techniques known in the art.

The 3 grooves in the rotor as illustrated in FIG. 1 may be formed as part of fabrication using an embossing technique in which the embossing tool is imprinted with a negative impression of the pattern to be created on the surface of the rotor. For example, the pattern on the rotor is for 3 grooves so the embossing tool includes 3 raised elements corresponding to the 3 grooves to be formed. For other patterns, the embossing tool includes a corresponding negative pattern.

To form the pattern on a surface of a part, force may be applied when pressing the embossing tool into the surface. Additionally, prior to embossing, the part may be heated to an elevated temperature other than room temperature in accordance with the materials comprising the rotor or other part being patterned. Heating may be used in combination with force applied to facilitate the embossing process. The amount of force or pressure used in connection with embossing, alone or in combination with heating, may vary with the materials comprising the part being patterned.

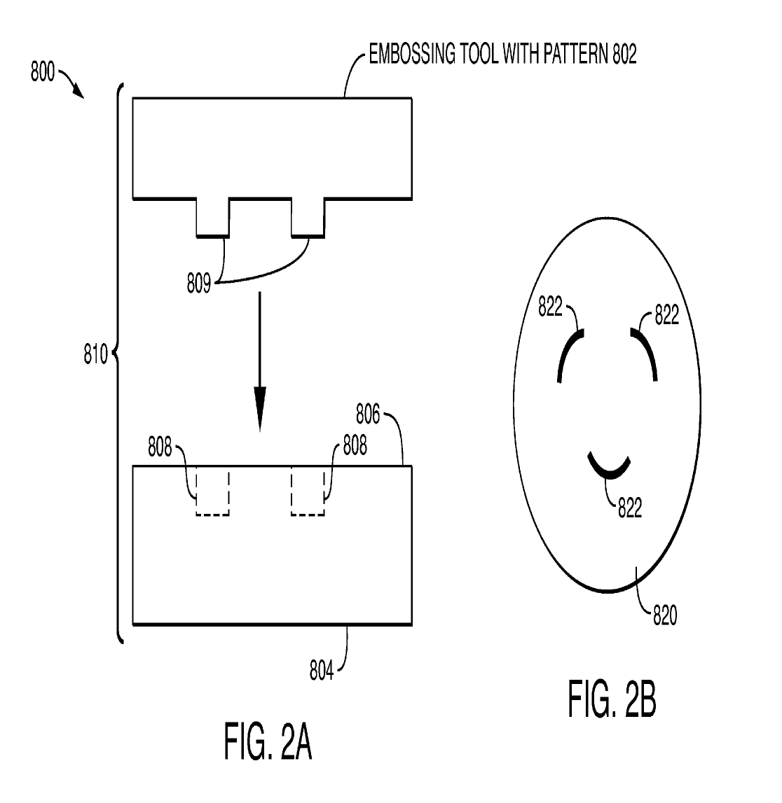

Referring to FIG. 2, shown is an example illustrating use of the embossing technique described herein. The example 800 includes an element 810 with an embossing tool with pattern 802, and a part 804 having a surface 806 to be embossed with the pattern of 808. The embossing tool 802 has a pattern formed thereon with extended portions 809 representing the negative impression of the pattern to be formed as indicated by 808. As described herein, the part 804 may be heated to a desired temperature. Subsequently, the embossing tool 802 may be applied with pressure to the surface 806 in the direction indicated by the arrow so as to compress the surface 806 causing displacement of material in accordance with the pattern on the embossing tool. When the embossing tool reaches the desired depth (e.g., in accordance with the depth needed to form 808), the force may be applied for a predetermined time period, such as 1 minute. Subsequently, the applied force may be removed and the embossing tool raised from the surface 806.

Element 820 illustrates a view looking at a surface of the embossing tool having a negative impression of the pattern formed thereon. It should be noted that the pattern may be characterized as negative with respect to the imprint 808. In this example of 820, the embossing tool that may be used for embossing the 3 grooves in the rotor described herein. Element 822 represents 3 protrusions in the surface of the embossing tool in the shape and location of the 3 desired grooves to be formed in the rotor so that when the embossing tool is applied to the rotor surface, the desired 3 groove pattern is produced. The embossing tool 802 may be made from any one of a variety of suitable materials suitable for the selected pressure and temperature and material of 804 being embossed.

Referring to FIG. 3, shown is a graphical illustration of tensile strength vs. temperature for different VICTREX PEEK materials as may be used in connection with the fabrication of the rotor. Info'illation such as that illustrated in 600 may be used in selecting a temperature and pressure applied in connection with the embossing techniques herein. The information in 600 is specific to the particular PEEK materials. However, it will be appreciated by those skilled in the art that similar information may be used in connection with other materials that may comprise the rotor or other part being embossed for selection of appropriate pressure and temperature ranges.

With reference to 600, element 602 may represent the approximate glass transition temperature for use with the listed PEEK materials and element 604 may represent the approximate melting point for the listed PEEK materials. The embossing techniques herein may be used in connection with a rotor formed from any one of the listed PEEK materials. In connection with one embodiment of a rotor made with PEEK material, such as the 450CA30

PEEK blend, and a 30% carbon fiber reinforcement, the rotor may be heated to a temperature selected from the temperature range of about 100 degrees Celcius (at around the glass transition temperature) to just below the melting point. It is at the melting point where the part will not retain its shape. Additionally the downward force or pressure applied may also vary with the material comprising the part and temperature to which the part is heated. Generally, a pressure may be selected which is less than the tensile strength indicated for a selected temperature. Element 600 illustrates graphically how the tensile strength of the various listed PEEK materials decreases as the temperature of the material is increased. As the temperature of the rotor is increased, the amount of pressure applied with the embossing technique herein may be decreased. As an example, in one embodiment, the rotor made of PEEK, such as the 450CA30 material, with a 30% carbon fiber reinforcement may be heated to a temperature of 185 degrees Celcius holding an applied force of 200 pounds for about a minute when embossing with embossing tool. An embodiment may select a temperature from a processing range based on when the materials of the rotor become ductile up to a temperature at which undesired affects to the rotor materials occur. A pressure may be selected in accordance with the temperature and the tensile strength of the materials at the selected temperature.

As described herein for embossing, whether to apply pressure alone or in combination with heating the part to be patterned depends on materials comprising the part and the mechanical properties thereof. Furthermore, selection of particular pressure and temperature values may also vary with the materials comprising the part being embossed.

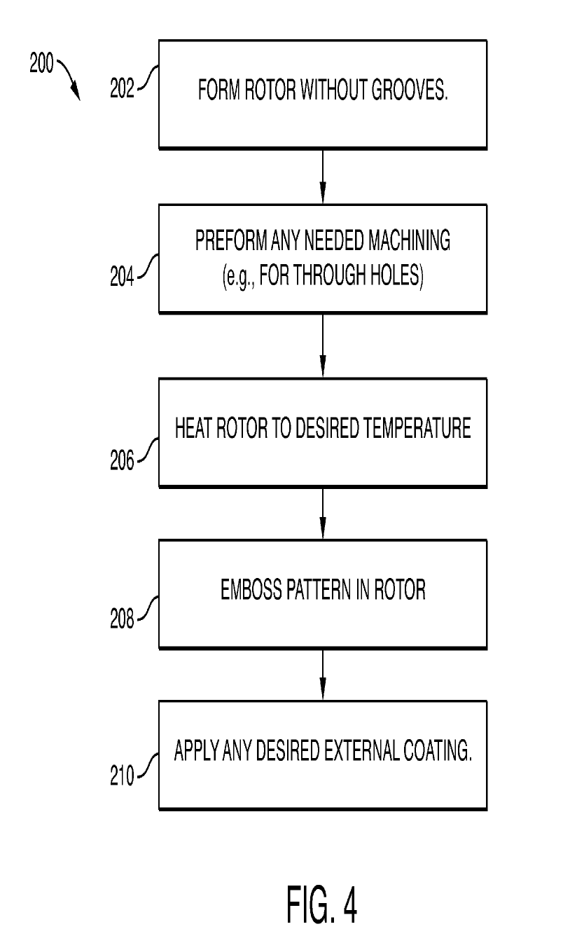

Referring to FIG. 4, shown is a flowchart of steps that may be performed in an embodiment in connection with fabrication of the rotor using the techniques herein. At step 202, the rotor may be formed without the 3 grooves therein. The rotor may be formed in step 202, for example, using injection molding or other techniques known in the art. At step 204, any needed machining to the rotor is performed. Step 204 may include, for example, forming any through holes needed as described herein in one embodiment (e.g., elements 415a-415c of FIG. 1). At step 206, the rotor is heated to the desired temperature. In one embodiment, the rotor may be made of PEEK with 30% carbon fiber reinforcement and may be heated to 185 degrees Celcius. The rotor or other part may be heated using any techniques known in the art. For example, the rotor may be heated in an oven to the desired temperature. At step 208, the rotor is then embossed with the desired pattern by applying sufficient force or pressure when embossing the surface of the part with the embossing tool as illustrated in FIG. 2. Pressure may be applied when depressing the embossing tool onto the surface to be patterned. For example, in one embodiment using a rotor made of PEEK with 30% carbon fiber reinforcement where the rotor is heated, 200 pounds of pressure may be applied for a time period of about 1 minute to form the 3 grooves as illustrated in FIG. 1. Once the embossing is complete, any desired external coating(s) may then be applied to the part in step 210.

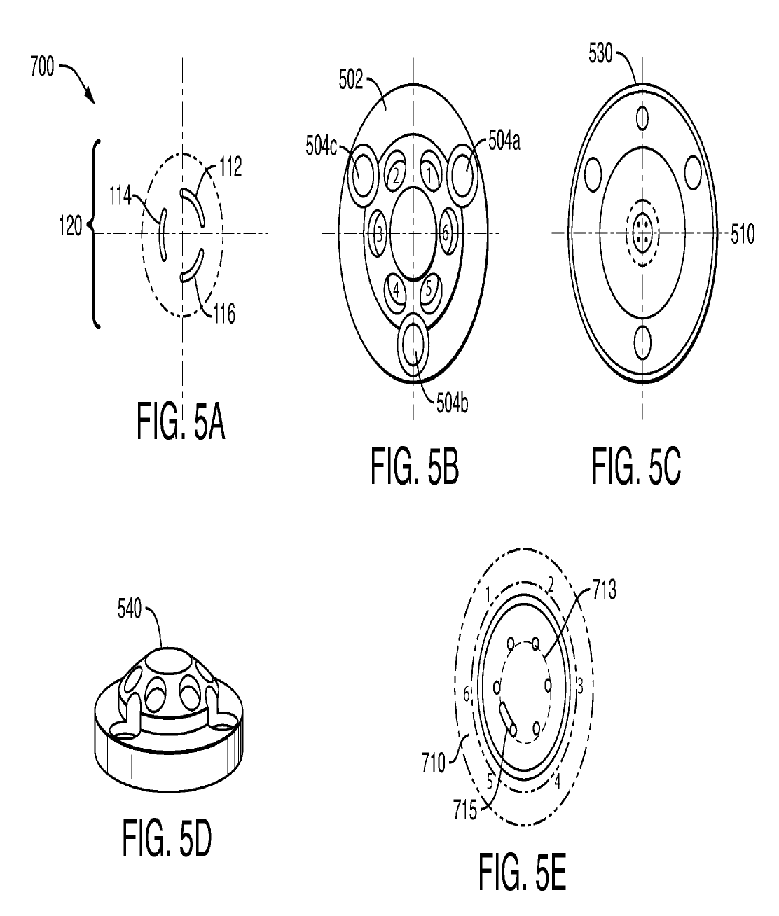

What has been described is using the embossing techniques herein in connection with fabrication of a rotor having grooves formed thereon. The rotor is in contact with a surface of the stator having no grooves formed thereon in the embodiment described above. In a second embodiment of injection valve parts fabricated using the embossing techniques herein, a pattern may be formed on a surface of the stator as well as on a surface of the rotor. In the second embodiment, the embossing techniques described herein may be used to produce a groove on a stator surface in contact with the rotor. The rotor and the stator that will be described in following paragraphs in connection with FIG. 5 may be included in an injection valve arrangement similar to that as described above. The rotor and stator of FIG. 2 may be used in an injection valve in an LC system such as, for example, the EverFlow™ Injection Valve included in HPLC systems by Waters Corporation.

Referring to FIG. 5, shown is an illustration providing more detail of another rotor and a stator that may be fabricated in an embodiment using the techniques herein. Element 120 provides an enlarged view of an inner portion of a surface of the rotor in which the grooves 112, 114 and 116 are formed using the embossing techniques described herein. As described in connection with the rotor of FIG. 1, the rotor of 120 may also have 3 grooves. However, the three grooves in the rotor of 120 are not the same size and volume. In this example, each of the grooves may have a width of 0.012+/−0.001 inches, may be located a same distance R from the center of the rotor, and may be shaped to extend along a portion of a same circumference of a circle having radius R. In the example illustrated in 120, the foregoing circle may have a diameter of 0.100 inches. Grooves 114 and 116 may have similar dimensions with a third groove 112 having a longer length than grooves 114, 116. Grooves 114 and 116 may have a sufficient length to extend about a portion of the foregoing circumference associated with a 60 degree angle as indicated. Groove 112 may have a sufficient length to extend about a portion of the foregoing circumference associated with a 74 degree angle as indicated.

The rotor having a pattern of 120 may be made of materials similar to those described above in connection with the rotor of FIG. 1. The rotor pattern illustrated by 120 may be produced using techniques and conditions similar to those described above in connection with the rotor of FIG. 1 using an appropriate embossing tool having the modified or different groove arrangement of element 120.

The remaining items 502, 530, 540 and 710 are exemplary illustrations of a stator that may be included in an embodiment of an injection valve using the rotor having the pattern of element 120. The stator illustrated by FIG. 5 is similar to that as described above and which is additionally fabricated using embossing techniques herein to have a pattern formed on a surface thereof. Element 502 provides a view of one surface of the stator including 6 ports. The face of the stator indicated in 502 may be the surface of the stator which does not come into contact with the rotor surface. Elements 504a-c may be through holes formed in the stator through which screws may be inserted as a means of securing the stator to other parts comprising the valve assembly. Element 530 provides a view of the opposing surface of the stator from that illustrated in 502. When included in an assembled injector valve, the surface illustrated in 530 faces the rotor having pattern 120. Element 540 provides an additional view of the stator. Element 710 provides a more detailed view of an inner portion of the stator surface of 530 facing the rotor. Element 715 indicates the additional groove that may be formed on the stator surface facing the rotor. In this example arrangement, the groove 715 may be located between ports 5 and 6 and may extend to about half way between ports 5 and 6 (e.g., to approximately the 30 degree position halfway between ports 5 and 6). The groove 715 may be formed using embossing techniques described herein. The groove 715 may also be referred to as a “make-before-break” groove for alleviating pressure surges that can occur. The port holes 1-6 as illustrated in 502 pass through the stator having corresponding openings 1-6 on the opposing surface as indicated in 710. The openings 1-6 in 710 may be located a same distance or radius R from the center of the stator along a circumference of a circle indicated by 713. The port holes 1-6 have corresponding openings in the surface of 710 and are positioned equidistant from each other along 713.

It should be noted the stator used in connection with the rotor of FIG. 1 may be similar to that as described in connection with FIG. 5 without having the groove 715. The rotor and stator described in connection with FIG. 5 may operate as generally described above in the injection valve having a first or loading position and a second or injection position. As described above for the loading position, the fluid path of the sample is formed by the sample entering at port 3 and passing through the groove between ports 3 and 4 into the sample loop (between ports 1 and 4). In the injection position, the fluid path of the sample is out of the sample loop, through the groove between ports 1 and 6, and out of port 6 to the LC column. Through actuating the rotor to different positions relative to a stationary stator, volumes of a sample may be injected into the LC system. The added groove 715 in the stator of FIG. 5 may be used to avoid pressure build up in the line of port 5 when actuating the injector valve where pressure may be used to force fluid from the sample loop to exit through port 6. When in the load position, the groove 112 of the rotor may be in alignment with, and extend between, port 6 and port 5 and then extend part way between ports 5 and 4. When in the injection position, the groove 112 of the rotor may be in alignment with, and extend between, port 4 and port 5, and then extend part way between ports 5 and 6 to also overlap with groove 715 of the stator.

The stator of FIG. 5 may be made of a type of stainless steel, or other suitable material, and may have a diamond-like carbon (DLC) coating formed on the surface facing the rotor as noted in element 710 inside the circular region defined by the indicated 0.21 inch diameter. For example, the stator may be a type of stainless steel alloy such as of type 316 (S31600), 318, Nitronic 60, A-286, Inconel 718, and the like. In one embodiment, the stator may be made of type 316 stainless steel having a tensile strength of 75,000 psi at room temperature. The steps as outlined in FIG. 4 may be used to fabricate the stator with appropriately selected temperature and pressure for the materials comprising the stator. With reference to FIG. 4, in step 202, the stator may be formed, such as by injection molding, without the groove 715 therein. In step 204, any needed machining may be performed, for example, to form any through holes. In an embodiment in which the stator is made of stainless steel, the stator may be heated in step 206 to a suitable temperature with application of a suitable pressure in connection with embossing in step 208. As described elsewhere herein in connection with the rotor, pressure may be applied alone, or in combination with, additional heating of the stator (e.g., temperature higher than room temperature) where pressure and, optionally, temperature, may be determined and vary with the particular composition of the stator. In step 210, an external coating, such as the DLC coating, may be applied using techniques known in the art such as using vaporization, masking, sputtering, and the like.

With reference back to FIG. 4, it should be noted that steps 204 and 210 may be optionally performed or omitted depending on the particular part. For example, when fabricating the stator, step 210 may include applying a hard coating such as the DLC coating or a nitride, titanium or chromium nitride coating using known techniques appropriate for the particular coating. It should also be noted that step 202 may vary with the particular part and may also include other processing steps. The fabrication processing may also include other steps than as illustrated in 200 as may be needed for a particular part.

The embossing tool used in connection with patterning the rotor and stator may be made of a hard metal, such as a type of stainless steel. The embossing tool may also be coated with a DLC or other coating as described above for the stator.

The selection of temperature, pressure, and amount of time for applying the pressure in connection with embossing may vary with the materials comprising the part being patterned. For example, in connection with the PEEK material as described herein when patterning the rotor, the rotor may be heated to 185 degrees Celcius and the embossing may be performed using a force of 200 pounds for about a minute. Whether embossing utilizes pressure, alone or in combination with heating of the part beyond room temperature, depends on the materials comprising the part being embossed and its mechanical properties.

An embodiment may also use a different technique besides embossing in connection with fabricating the pattern in a part surface. With reference to the injection valve, the grooves in the rotors described in connection with FIGS. 1 and 5A may be fabricated using injection molding. In other words, the injection mold of the rotor may be formed to include the negative impression of the grooved pattern directly therein. With reference to FIG. 4 in such an embodiment, steps 206 and 208 may be omitted in connection with groove fabrication.

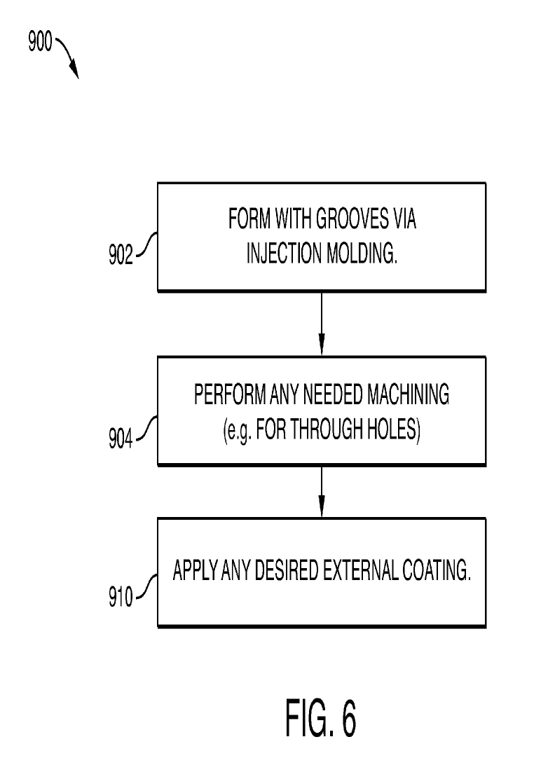

Referring to FIG. 6, shown is a flowchart of processing steps that may be performed in an embodiment in connection with a second technique that may be used for rotor fabrication.

The rotor may be made of materials as described above. At step 902, the rotor may be formed with the grooves therein via injection molding. The groove fabrication using an injection mold has the appropriate pattern corresponding to the grooves or other pattern formed directly therein. With reference back to FIG. 2, the injection mold may have a shape in accordance with the grooves as indicated by 808 so that the rotor formed as a result of the injection molding step 902 has the grooves formed therein. At step 904, any needed machining may be performed. Step 904 is analogous to step 204 as described in connection with FIG. 4. At step 910, any desired external coating may be applied to the rotor. It will be appreciated by those skilled in the art that using an injection mold including the desired grooves or other pattern formed directly therein may be used in connection with fabricating other surface patterns and other injection valve parts besides a rotor. In a manner similar to that as described above for forming rotor grooves, the stator and grooves formed on a surface of the stator may also be formed using injection molding using suitable materials, such as, for example, stainless steel as described above. Also, the steps of FIG. 6 may be used in connection with fabricating parts of other valves as well as other components of a system besides an injection valve. Generally, parts that can be made using injection molding can utilize an injection mold having the groove or other desired surface pattern formed directly in the mold.

It should be noted that a surface of a part may be patterned using a combination of different techniques. For example, a part, such as a rotor, may have one pattern formed on a surface using injection molding and a second pattern formed on the same surface or a different surface using the embossing technique described herein. As another example, a part, such as the rotor, may have one pattern formed on a surface using injection molding or embossing as described herein, and may also have a second pattern formed on the same or a different surface using machining, such as by drilling.

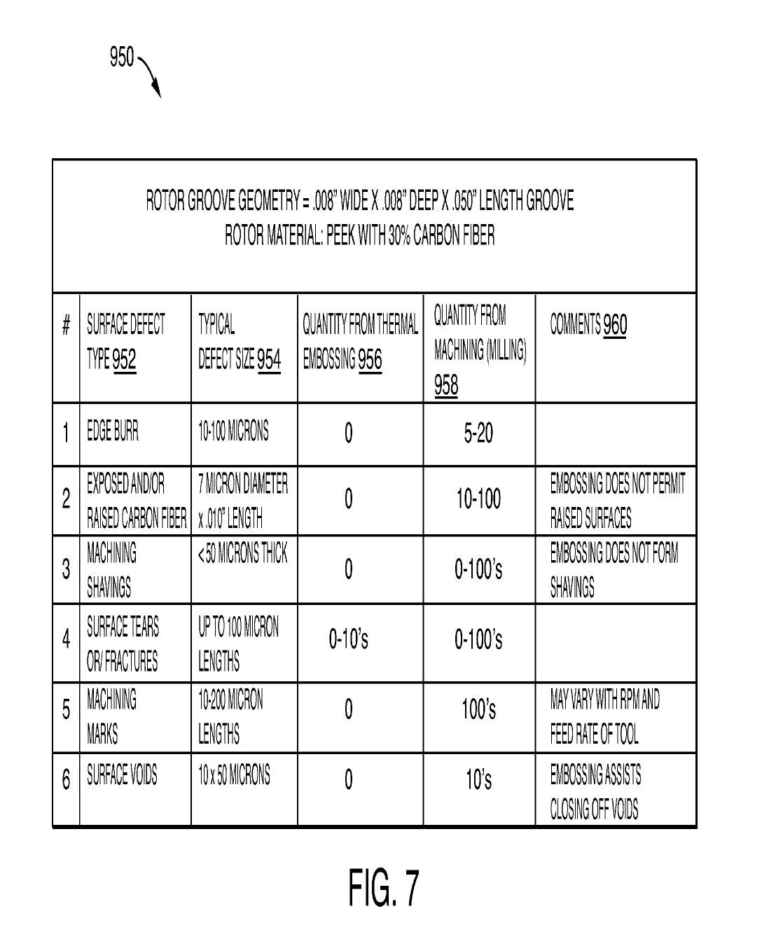

Referring to FIG. 7, shown is a table of exemplary surface defects and characterizations resulting from producing a patterned surface using machining and embossing techniques described herein. The table 950 identifies 6 types of surface defects or undesirable surface effects in column 952 that may produced as a result of forming a pattern in a surface. For each surface defect, the table 950 indicates an exemplary defect size 954, a quantity of the defect observed when a groove is formed using the embossing technique with heating (also referred to as thermal embossing) 956, a quantity of the defect observed when the groove is formed using machining (milling) 958, and comments 960. As known in the art, the machining technique used in obtaining the data for the table 950 may also be characterized as milling using a ball mill which cuts into a surface to form a groove or other desired pattern. The information of 950 was obtained from viewing sample rotors using a Zeiss SEM (scanning electron microscope) at various magnifications in a range of approximately 50 to 1000 times. Grooves were formed in a rotor where each groove has an approximate size of 0.008″ wide×0.008″ deep×0.050″ length. The rotor was made from the PEEK material 450CA30 (as illustrated in FIG. 3) with 30% carbon fiber. When forming the groove using the embossing technique herein, the rotor was heated to 185 degrees Celcius and held for a time period at an appropriate pressure such as described above. The quantities specified in columns 956 and 958 represent observed quantities of the typical defect size 954.

Column 952 identifies the following types of surface defects—(1) edge burr, (2) exposed and/or raised carbon fiber, (3) machining shavings, (4) surface tears or fractures, (5) machining marks, and (6) surface voids. An edge burr (1) may be characterized as a fiber laterally overhanging or extending from the groove perimeter into the groove. An edge burr occurs only at the edge perimeter length of the groove. All other types of defects 2-6 occur on a surface within the groove (e.g., on the surface area of the groove). Exposed and raised carbon fibers (2) may be characterized as fibers protruding or extending upward from the surface area of the groove. Machine shavings (3) are shavings of the material removed by the machining process as the groove is formed which adhere to the surface area within the groove. As the ball mill used with machining cuts through the polymer and fiber to form the groove, slices of the polymer and fiber forming the machine shavings may be redeposited back onto the surface and may not be easily washed away. Machining marks (5) may be characterized as the uneven surface within the groove formed as a result of cuts made with the machining tool. Each machining mark may appear as an indentation in a surface within the groove so that collectively, multiple machining marks formed on the surface within the groove may give the appearance of a rippled surface area having multiple curved indentations. Each curved indentation may be quantified as a machining mark. Machining marks are created by the diameter of the ball mill. Machining marks increase the surface area within the groove creating additional area for a sample to possibly cling thereby affecting sample recovery. A surface void (6) may be characterized as a void formed in the surface area of the groove. A surface void may have both a length and width dimension. Surface tears or fractures (4) may be visually observed as long thin lines in the surface area of the groove. Surface tears may be characterized as a type of void having a width less than a specified threshold so that the width is not specified as a dimension to the defect. In other words, surface tears and fractures may be characterized as voids in the surface area of the groove having length with negligible width. Surface tears or fractures (4) may be formed as a result of the ball mill wearing. As the ball mill begins to wear, the ability for the ball mill to sharply cut into the polymer during machining diminishes and the polymer begins to tear away from the surface area causing the surface tears or fractures.

In connection with defect 1, edge burr, the quantities observed as specified in columns 956 and 958 varies with the perimeter of the groove. In this example, the groove perimeter is (0.008″×2)±(0.050″×2)=0.116 inches. For the remaining defects 2-6 the quantities observed as specified in columns 956 and 958 varies with the surface area of the groove. In this example, the groove surface area is approximately [(0.050″×008×3]+[(0.008″×0.008″)×2]=0.001328″ square inches. As specified in the table 950, using the embossing technique herein with heating of the rotor (e.g., thermal embossing) resulted in only observing type 4 defects, surface tears. Embossing may cause tears as the rotor material is deformed to form the groove. However, the range of observed quantity of surface tears (4) for thermal embossing is smaller than that associated with machining.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method for fabricating one or more parts of a valve used in a liquid chromatography system comprising:
providing at least one of a rotor and a stator, wherein said rotor is included in said valve and has a first surface facing a stator, and said stator is included in said valve and has a second surface facing said rotor; and
patterning at least one of said first surface and said second surface, said patterning including compressing said at least one surface by applying pressure thereto causing displacement of material from said at least one surface to form at least one groove.

2. The method of claim 1, wherein said valve is an injection valve.

3. The method of claim 1, wherein said patterning patterns said first surface of said rotor.

4. The method of claim 3, wherein said rotor is comprised of a PEEK polymer material using carbon fiber reinforcement.

5. The method of claim 3, wherein said patterning further comprises:
heating said rotor; and
compressing said first surface by applying pressure thereto using an embossing tool causing displacement of material to form at least one groove, said embossing tool having a negative impression of a pattern formed on said first surface.

6. The method of claim 3, wherein said rotor is comprised of a base polymer and one or more other materials in a homogeneous combination.

7. The method of claim 6, wherein said base polymer is one of a PEEK material, Ryton PPS, VESPEL SP1, and a polyimide.

8. The method of claim 6, wherein said one or more other materials includes carbon or glass fibers.

9. The method of claim 6, wherein said one or more other materials includes one or more filler materials.

10. The method of claim 9, wherein said one or more filler materials includes one or more of Teflon and graphite.

11. The method of claim 5, wherein said embossing tool is made of steel.

12. The method of claim 1, wherein said patterning includes forming at least one groove on said first surface and at least one groove on said second surface.

13. The method of claim 12, wherein said rotor is made of a base polymer and one or more other materials.

14. The method of claim 12, wherein said stator is made of stainless steel.

15. The method of claim 12, wherein said valve is a rotary injection valve.

16. The method of claim 12, further comprising:
heating said stator and heating said rotor prior to performing said compressing.

17. A method for fabricating parts of a valve comprising:
providing at least one of a rotor and a stator, wherein said rotor is included in said valve and has a first surface facing a stator, and said stator is included in said valve and has a second surface facing said rotor; and
forming at least one groove on at least one of said first surface and said second surface, said at least one groove being formed using a process without machining said at least one surface to form said at least one groove.

18. The method of claim 17, wherein said at least one groove is formed by compressing said at least one surface to displace material from said surface.

19. The method of claim 17, wherein said at least one groove is formed using injection molding.

20. The method of claim 17, wherein said at least one groove is formed by embossing a pattern on said at least one surface using an embossing tool.

21. The method of claim 20, wherein said forming step forms at least one groove in said first surface and at least one groove in said second surface.

22. The method of claim 21, wherein said rotor and said stator are heated, and said method comprising:
embossing a first pattern including at least one groove on said first surface of said rotor by applying pressure when depressing a first embossing tool onto said first surface; and
embossing a second pattern including at least one groove on said second surface of said stator by applying pressure when depressing a second embossing tool onto said second surface.

23. The method of claim 17, wherein a first groove is formed in one of the first and second surfaces by heating said one surface containing said first groove prior to forming said first groove.

24. The method of claim 23, wherein there are no edge burrs formed at a perimeter of said first groove, no exposed or raised fibers on a surface area of said first groove, and no surface voids formed on a surface area of said first groove.

25. A method for fabricating one or more parts of a valve in a chromatography system comprising:
providing at least one of a rotor and a stator, wherein said rotor is included in said valve and has a first surface facing a stator, and said stator is included in said valve and has a second surface facing said rotor; and
patterning at least one of said first surface and said second surface, said patterning including performing one or more of: compressing said at least one surface by applying pressure thereto causing displacement of material to form at least one groove, and using a mold having at least one groove formed therein.

26. A rotor comprising at least one groove formed on a surface thereof wherein there are no edge burrs formed at a perimeter of said at least one groove, no exposed or raised fibers on a surface area within said at least one groove, and no surface voids formed on a surface area within said at least one groove.

27. A stator comprising at least one groove formed on a surface thereof wherein there are no edge burrs formed at a perimeter of said at least one groove, no exposed or raised fibers on a surface area within said at least one groove, and no surface voids formed on a surface area within said at least one groove.

28. An injector valve comprising:
a rotor and a stator, wherein at least one groove is formed on at least one surface of the rotor or the stator, said at least one groove having no edge burrs formed at a perimeter of said at least one groove, no exposed or raised fibers on a surface area within said at least one groove, and no surface voids formed on a surface area within said at least one groove.
